(19) United States
(12) Patent Application Publication
(10) Pub. No.: US 2019/0245302 A1
(43) Pub. Date: Aug. 8, 2019

(54) ELECTRONIC DEVICE AND RECEPTACLE CONNECTOR

(71) Applicant: KYOCERA CORPORATION, Kyoto (JP)

(72) Inventors: Kenichi Ozasa, Yokohama-shi (JP); Talchi Kim, Yokohama-shi (JP)

(21) Appl. No.: 16/263,745

(22) Filed: Jan. 31, 2019

(30) Foreign Application Priority Data
Feb. 5, 2018 (JP) 2018-018140

(51) Int. Cl. H01R 13/629; H01R 13/52; H01R 24/60

(52) U.S. Cl. CPC H01R 13/629; H01R 24/60; H01R 13/52

(57) ABSTRACT

Provided is an electronic device comprising an improved receptacle connector and an improved receptacle connector. The electronic device comprises a terminal component configured to include a contact electrically connect to a plug connector and a guide configured to guide the plug connector inserted from outside to the terminal component. The guide and the terminal component constitute a receptacle connector having no metal shell.

### CROSS REFERENCE TO RELATED APPLICATIONS

The present application claims priority to and the benefit of Japanese Patent Application No. 2018-018140 filed Feb. 5, 2018, the entire contents of which are incorporated herein by reference.

### TECHNICAL FIELD

This disclosure relates to an electronic device and a receptacle connector.

### BACKGROUND

Conventionally, an electronic device provided with a connector has been known. The connector provided in the electronic device has a metal shell.

### SUMMARY

An electronic device according to an embodiment of this disclosure includes: a terminal component configured to include a contact electrically connected to a plug connector; and a guide configured to guide the plug connector inserted from outside to the terminal component. The guide and the terminal component constitute a receptacle connector having no metal shell.

An electronic device according to an embodiment of this disclosure includes a receptacle connector. The receptacle connector has a terminal component configured to include a contact electrically connected to a plug connector and a guide configured to guide the plug connector inserted from outside to the terminal component. The contact is opposed to the guide.

A receptacle connector according to an embodiment of this disclosure has a terminal component configured to include a contact electrically connected to a plug connector and a guide configured to guide the plug connector inserted from outside to the terminal component. The contact is opposed to the guide.

### BRIEF DESCRIPTION OF THE DRAWINGS

In the accompanying drawings:

FIG. 1 illustrates an outer perspective view of an electronic device according to an embodiment of this disclosure;

FIG. 2 is a bottom view of the electronic device illustrated in FIG. 1;

FIG. 3 is a cross-sectional view of the electronic device taken from L1-L1 line in FIG. 1;

FIG. 4 is a cross-sectional view of the electronic device taken from L2-L2 line in FIG. 1;

FIG. 5 is a diagram illustrating a state where a back cover and the like are removed from the electronic device illustrated in FIG. 1;

FIG. 6 is a diagram illustrating a configuration of the terminal component illustrated in FIG. 3;

FIG. 7 illustrates a state where a waterproof member is removed from the terminal component illustrated in FIG. 6, viewed from the Z-axis negative direction side;

FIG. 8 illustrates a state where the waterproof member is removed from the terminal component illustrated in FIG. 6, viewed from the Z-axis positive direction side;

FIG. 9 is a cross-sectional view of an electronic device according to a comparative example; and

FIG. 10 is a diagram of an example of a manufacturing process of the electronic device illustrated in FIG. 1.

### DETAILED DESCRIPTION

The connector provided in the conventional electronic device has room for improvement.

It would be helpful to provide an electronic device provided with an improved receptacle connector and an improved receptacle connector.

According to this disclosure, an electronic device including an improved receptacle connector and an improved receptacle connector are provided.

An embodiment according to this disclosure will be described below with reference to drawings.

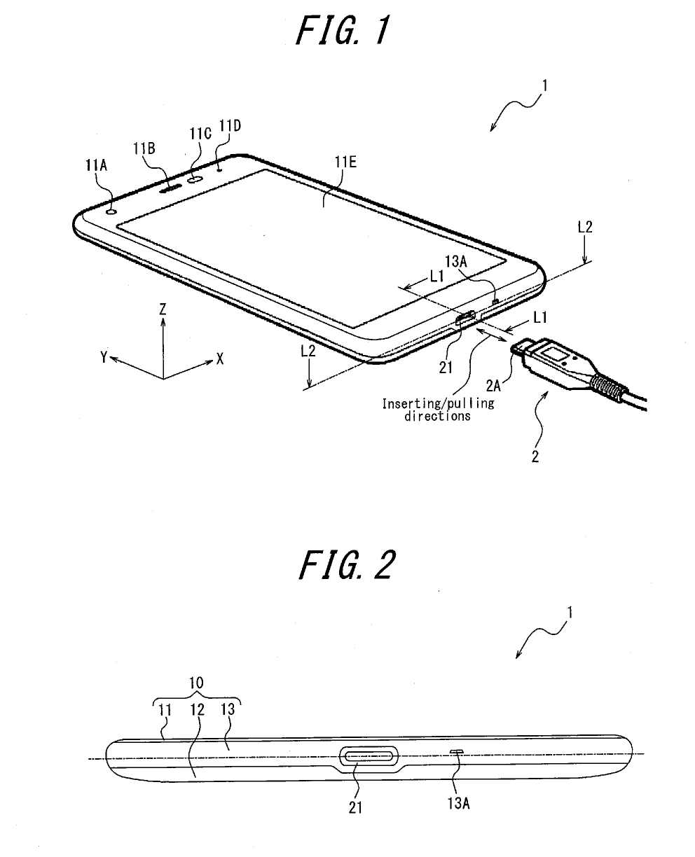

FIG. 1 is an outer perspective view of an electronic device 1 according to an embodiment of this disclosure. FIG. 2 is a bottom view of the electronic device 1 illustrated in FIG. 1.

The electronic device 1 may be plate-like as illustrated in FIG. 1. Hereinafter, with respect to the plate-like electronic device 1, the longitudinal direction, the lateral direction and the thickness direction of the electronic device 1 are referred to as the Y-direction, the X-direction and the Z-direction, respectively.

The electronic device 1 is a smartphone. However, the electronic device 1 is not limited to a smartphone. For example, the electronic device 1 may be a tablet terminal, a mobile phone, a phablet, a tablet PC, a feature phone, a Personal Digital Assistant (PDA), a remote controller terminal, a mobile music player, a game machine or an e-book reader and the like.

The electronic device 1 can be electrically connected to another device via a plug connector 2. For example, the electronic device 1 can be electrically connected to an outer power source via the plug connector 2. The battery of the electronic device 1 can be charged by the power supplied from the outer power source.

The plug connector 2 can be inserted into/pulled out of the electronic device 1. The direction of inserting the plug connector 2 into the electronic device 1 and the direction of pulling the plug connector 2 out of the electronic device 1 are collectively referred to as the “inserting/pulling directions.” In this embodiment, the inserting/pulling directions are approximately parallel to the Y-axis direction.

The plug connector 2 includes a shell 2A. The shell 2A can be made from metal. The plug connector 2 includes a contact in the shell 2A.

As illustrated in FIG. 2, the electronic device 1 includes a housing 10. The housing 10 protects the internal structure of the electronic device 1. It is to be noted that the “housing” according to this disclosure may include an outer casing and a frame. The outer casing may constitute the outer surface of the electronic device 1. The frame may support any component of the electronic device 1.

As illustrated in FIG. 2, the housing 10 includes a front panel 11, a back cover 12 and an intermediate housing 13. However, members included in the housing 10 are not limited to the front panel 11, the back cover 12 and the intermediate housing 13. For example, the housing 10 may include a case that accommodates an internal structure of the electronic device 1 and an upper plate that can be a lid of the case.

The front panel 11 may be made of any materials. Any materials may include glasses and synthetic resins. At least a part of the front panel 11 may have a transparency. As illustrated in FIG. 1, a camera 11A, a receiver 11B, a proximity sensor 11C and a lamp 11D may be disposed on the front panel 11. A display device 11E may be disposed on the side of the front panel 11 opposed to the back cover 12, that is, on the Z-axis negative direction side of the front panel 11.

The camera 11A takes a picture of an object that faces the front panel 11. The camera 11A may be a digital camera.

The receiver 11B converts a voice signal transmitted from a controller of the electronic device 1 into voice and outputs it. The voice of the other party is output from the receiver 11B during call.

The proximity sensor 11C detects a presence of a nearby object without making contact with the object. For example, the proximity sensor 11C detects a face of a user during call as a nearby object. When the proximity sensor 11C detects a presence of a nearby object, the controller of the electronic device 1 turns off the display of the display device 11E.

The lamp 11D lights up on incoming calls and the like. The lamp 11D may be configured by including a Light Emitting Diode (LED).

The display device 11E may be configured by including a Liquid Crystal Display (LCD), an organic Electro Luminescence (EL) or an inorganic EL and the like. The display device 11E may be a touch screen display. The touch screen display detects a contact of a finger, a stylus pen and the like and specifies its position. The user sees through the front panel 11 to visually confirm the display device 11E.

The back cover 12 may be made of any materials. The materials may include metals and synthetic resins. An out-camera and the like may be disposed on the back cover 12.

The intermediate housing 13 may be made of any materials. The materials may include metals and synthetic resins. A jack 21 into which the plug connector 2 can be inserted may be formed in the intermediate housing 13. A microphone 13A may be disposed in the intermediate housing 13.

During call, the microphone 13A collects voice of the user and ambient sound. The microphone 13A converts the collected sound into an electrical signal and outputs it to the controller of the electronic device 1.

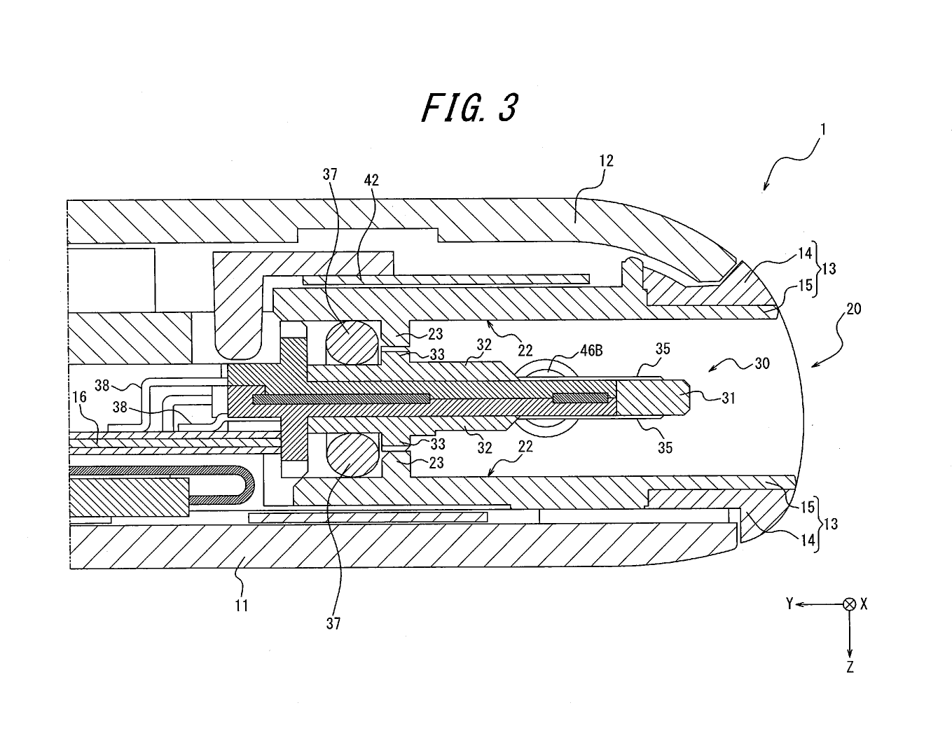

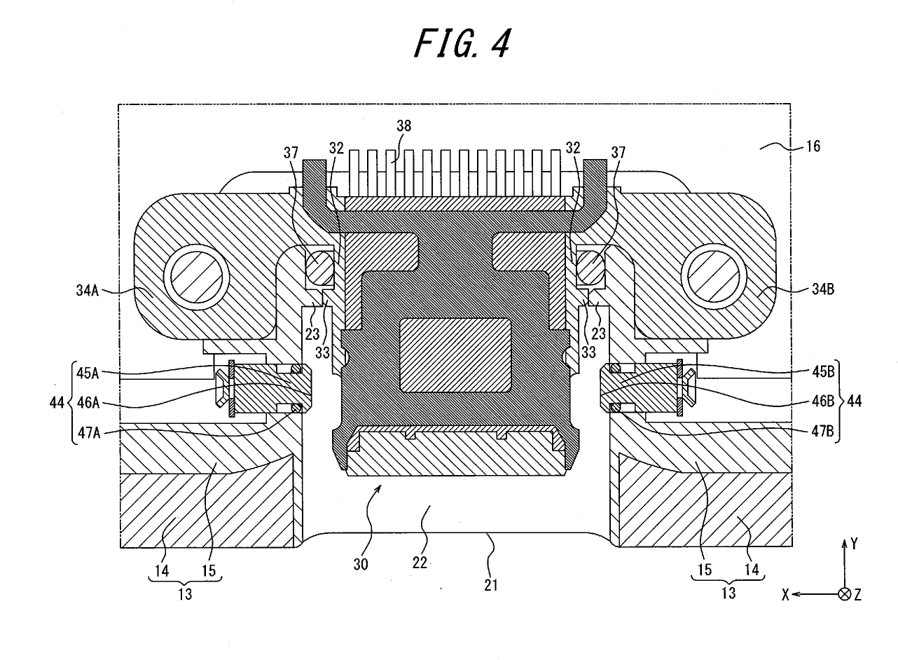

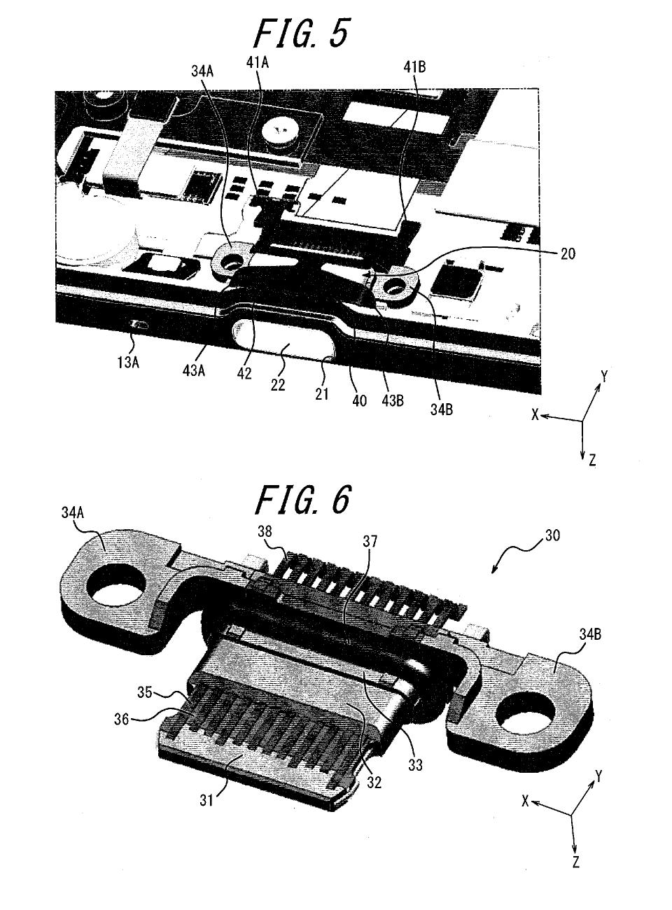

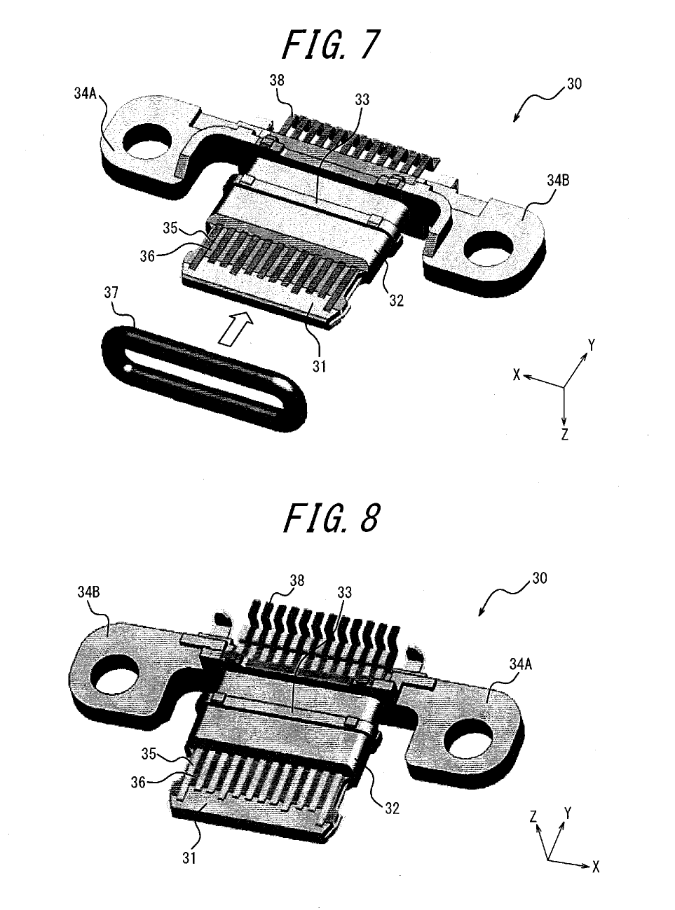

FIG. 3 is a cross-sectional view of the electronic device 1 taken from L1-L1 line in FIG. 1. FIG. 4 is a cross-sectional view of the electronic device taken from L2-L2 line in FIG. 1. FIG. 5 is a diagram illustrating a state where a back cover 12 and the like are removed from the electronic device 1 illustrated in FIG. 1. FIG. 6 is a diagram illustrating a configuration of the terminal component 30 illustrated in FIG. 3. FIG. 7 illustrates a state where a waterproof member 37 is removed from the terminal component 30 illustrated in FIG. 6, viewed from the Z-axis negative direction side. FIG. 8 illustrates a state where a waterproof member 37 is removed from the terminal component 30 illustrated in FIG. 6, viewed from the Z-axis positive direction side.

As illustrated in FIG. 3, the electronic device 1 includes a first housing 14 and a second housing 15 as the intermediate housing 13. Furthermore, the electronic device 1 includes a circuit board 16 and a receptacle connector 20. However, the components included in the electronic device 1 are not limited to these components. The electronic device 1 may include any components. For example, the electronic device 1 may include a controller, a memory and a battery.

The controller of the electronic device 1 controls whole electronic device 1. The controller may include one or more processors. For example, the controller may include a general purpose processor configured to read in a specific program to execute a specific function and a processor dedicated to a specific processing. The memory stores a program to be executed by the controller. The memory includes a semiconductor memory and a magnetic memory. The battery can supply power to at least one component of the electronic device 1.

At least a part of the first housing 14 may be made from metal. The first housing 14 may serve as an antenna. The second housing 15 may be made of synthetic resin. The second housing 15 may constitute a part of the frame of the electronic device 1.

For example, the circuit board 16 may be a Printed Circuit Board (PCB). A variety of electronic components may be mounted on the circuit board 16. For example, a part of a wiring line 38 of the terminal component 30 described below may be mounted on the circuit board 16. For example, the above described processor may be mounted on the circuit board 16.

The receptacle connector 20 is fitted with the plug connector 2 illustrated in FIG. 1. The receptacle connector 20 may be configured in accordance with a predetermined standard. The predetermined standard may include the Universal Serious Bus (USB) standard and the Lightning® standard. The USB standard may include Mini-USB, Micro-USB and USB Type C. The Mini-USB may include Type A and Type B. The Micro-USB may include Type A and Type B.

As illustrated in FIGS. 3 and 4, the receptacle connector 20 may have the jack 21, the guide 22, the protrusion 23 and the terminal component 30. Furthermore, as illustrated in FIG. 5, the receptacle connector 20 may have a conductive member 40.

The shell 2A of the plug connector 2 illustrated in FIG. 1 is insertable into and removable from the jack 21. The jack 21 may be formed on any face included in the outer surface of the electronic device 1. For example, the jack 21 may be formed in a face of the outer surface of the electronic device 1, the face being approximately parallel to the ZX plane and being located on the Y-axis negative direction side, as illustrated in FIG. 2, that is, in the bottom surface of the electronic device 1. For example, the jack 21 may be formed in a face of the outer surface of the electronic device 1, the face being approximately parallel to the YZ plane and being located on the X-axis negative direction, that is, in the face on the left side of the electronic device. For example, the jack 21 may be formed in a face of the outer surface of the electronic device 1, the face being approximately parallel to the YZ plane and being located on the X-axis positive direction side, that is, in the face on the right side of the electronic device.

Depending on the place where the receptacle connector 20 is formed, the guide 22 may be formed at any component included in the electronic device 1. For example, the guide 22 may be formed at the housing 10. In this example, the guide 22 may be formed at the second housing 15 of the housing 10 as illustrated in FIGS. 3 and 4. Further, if the housing 10 includes a case, the guide 22 may be formed at the case.

The guide 22 guides the plug connector 2 inserted from outside illustrated in FIG. 1 to the terminal component 30. The guide 22 may be formed into a shape that depends on the outer shape of the shell 2A of the plug connector 2. For example, if the shell 2A has an approximately rectangular solid shape, the guide 22 may have a tubular shape corresponding to the outer shape of the approximately rectangular solid shape. The guide 22 may be provided with a lock mechanism in accordance with a predetermined standard to which the receptacle connector 20 conforms.

When the electronic device 1 is plate-like parallel to the XY plane as illustrated in FIG. 1, the guide 22 may be approximately parallel to the plate-like electronic device 1. That is, as illustrated in FIG. 3, the guide 22 may be approximately parallel to the XY plane. When the guide 22 is approximately parallel to the plate-like electronic device 1, the thickness of the electronic device 1 can be reduced.

The guide 22 may have a flexibility. When the second housing 15 is made of material such as synthetic resin having flexibility, the guide 22 may be formed at the second housing 15. When the plug connector 2 illustrated in FIG. 1 is inserted into/removed from the jack 21, the front end of the shell 2A may hit the guide 22. Even if the front end of the shell 2A hits the guide 22, since the guide 22 has flexibility, the probability can be reduced that the front end of the shell 2A will be damaged.

The guide 22 may be non-conductive. When the second housing 15 is made of material such as non-conductive synthetic resin and the like, the guide 22 may be formed at the second housing 15. Here, when the plug connector 2 illustrated in FIG. 1 is inserted into/removed from the jack 21, the shell 2A and the guide 22 may come in contact with one another. Even if the shell 2A and the guide 22 come in contact with one another, if the guide 22 is non-conductive, the probability can be reduced that a short circuit may occur between the shell 2A and the component of the electronic device 1 through the guide 22.

The protrusion 23 protrudes from the guide 22 toward the terminal component 30. As illustrated in FIG. 3, the protrusion 23 may be formed at the guide 22. The protrusion 23 may be formed along the circumferential direction of the guide 22. The protrusion 23 may be formed at the position opposed to the protrusion 33 of the terminal component 30.

When the receptacle connector 20 and the plug connector 2 illustrated in FIG. 1 are fitted to each other, the protrusion 23 comes in abutment with the front end of the plug connector 2. For example, the protrusion 23 comes in abutment with the shell 2A of the plug connector 2, which is the front end of the plug connector 2. When the protrusion 23 comes in abutment with the front end of the plug connector 2, the shell 2A can remain at an appropriate position in the receptacle connector 20.

The terminal component 30 may be configured in accordance with a predetermined standard to which the receptacle connector 20 conforms. The terminal component 30 may be fixed to the circuit board 16. As illustrated in FIG. 6, the terminal component 30 may include a base 31, a housing 32, the protrusion 33, fixed portions 34A and 34B, a contact 35, a resin portion 36, a waterproof member 37 and a wiring line 38. The base 31, the housing 32, the protrusion 33 and the fixed portions 34A and 34B may be integrally formed by any, material including synthetic resin and the like.

A plurality of contacts 35 are disposed on the base 31. The housing 32 holds the contacts 35. The base 31 and the housing 32 may be inserted into the shell 2A of the plug connector 2 illustrated in FIG. 1.

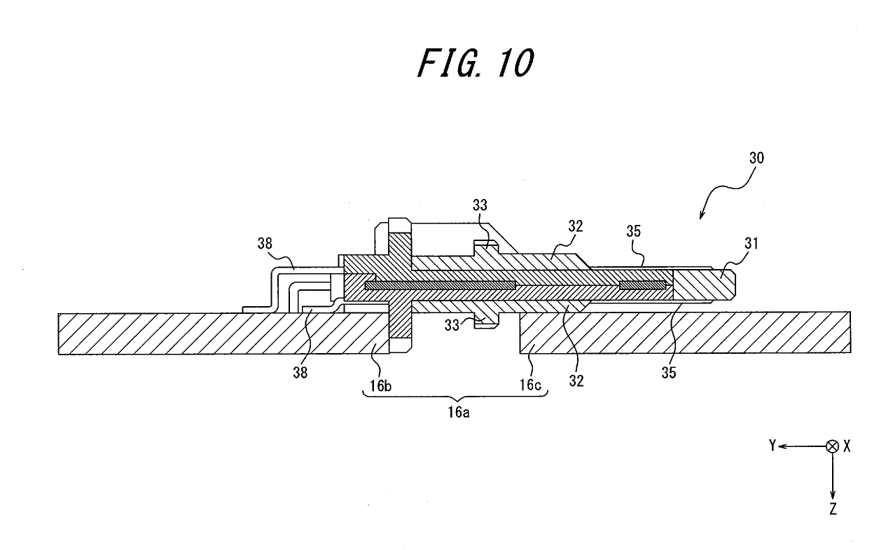

A part of the outer surface of the housing 32 may be located on the extension of the circuit board 16. In other words, the terminal component 30 may further include a face in the vicinity of the contact 35, the face being located on the extension of the circuit board 16. With this configuration, the base 31 can be approximately parallel to the circuit board 16. When the base 31 is approximately parallel to the circuit board 16, the base 31 can be smoothly inserted into the shell 2A illustrated in FIG. 1. An example of manufacturing process for placing a part of the outer surface of the housing 32 on the extension of the circuit board 16 will be described later with reference to FIG. 10.

As illustrated in FIGS. 3 and 4, the protrusion 33 may be formed on the housing 32 such that it comes in contact with the protrusion 23. In other words, the position of the protrusion 33 may be appropriately determined depending on the position of the protrusion 23. With this configuration, for example, when the electronic device 1 is assembled, the terminal component 30 can be disposed on an appropriate position of the guide 22 by aligning the position of the protrusion 33 with the position of the protrusion 23. It is to be noted that the protrusion 33 may be formed depending on the shape of the protrusion 23. For example, when the protrusion 23 is formed along the circumferential direction of the guide 22, the protrusion 33 may be formed along the circumferential direction of the housing 32.

As illustrated in FIGS. 4 and 5, the fixed portions 34A and 34B are fixed to the circuit board 16. For example, the fixed portions 34A and 34B may be fixed to the circuit board 16 with bonding members, or fixed to the circuit board 16 with fastening members such as screws. When fastening members such as screws are used, a hole for inserting a fastening member therethrough as illustrated in FIG. 6 may be formed in the fixed portions 34A and 34B.

The number and configuration of the contacts 35 may be in accordance with the predetermined standard to which the receptacle connector 20 conforms. For example, when the receptacle connector 20 conforms to the USB Type C of the USB standard, the contact 35 may be disposed both on the face on the Z-axis negative direction side of the base 31 and on the face on the Z-axis positive direction side of the base 31, as illustrated in FIGS. 7 and 8.

The contact 35 is opposed to the guide 22. The whole surface of the contact 35 may be opposed to the guide 22. For example, as illustrated in FIG. 3, the contact 35 disposed on the face on the Z-axis negative direction side of the base 31 may be opposed to the guide 22 located on the back cover 12 side. For example, the contact 35 disposed on the face on the Z-axis positive direction side of the base 31 may be opposed to the guide 22 located on the front panel 11 side.

The contact 35 can be electrically connected to the plug connector 2 illustrated in FIG. 1. More specifically, the contact 35 can be electrically connected to the contact placed in the shell 2A of the plug connector 2.

Each resin portion 36 is formed between contacts 35. For example, the resin portion 36 and the contact 35 may be integrally formed by inserting resin that will be the resin portion 36 between contacts 35. When the resin portion 36 and the contact 35 are integrally formed, the probability can be reduced that the water will enter between contacts 35.

The waterproof member 37 may be an annular packing as illustrated in FIGS. 6 and 7. The packing may be formed of elastic rubber material. The rubber material may include nitrile rubber, silicone rubber and urethane rubber. As illustrated in FIG. 7, the waterproof member 37 may be fitted to the housing 32 by passing the base 31 through a hole of the annular waterproof member 37. It is to be noted that the waterproof member 37 is not limited to packing. For example, the waterproof member 37 may be formed of adhesion agent.

As illustrated in FIGS. 3 and 4, the waterproof member 37 seals at least a part between the housing 32 and the guide 22. For example, when the waterproof member 37 is an elastic packing, the waterproof member 37 may be deformed by being pressed by the housing 32 and the guide 22 such that it seals between the housing 32 and the guide 22. For example, when the waterproof member 37 is adhesive agent, the waterproof member 37 may be applied between the housing 32 and the guide 22 such that it seals between the housing 32 and the guide 22. When the waterproof member 37 seals between the housing 32 and the guide 22, the probability can be reduced that the water will enter from the jack 21 into the electronic device 1.

As illustrated in FIGS. 3 and 4, the waterproof member 37 may be located on the inside of the protrusion 23 in the electronic device 1. Here, as described above, the protrusion 23 comes in abutment with the front end of the plug connector 2 as illustrated in FIG. 1. When the waterproof member 37 is located on the inside of the protrusion 23 that comes in abutment with the front end of the plug connector 2 in the electronic device 1, the probability can be reduced that the water attached to the plug connector 2 will enter into the electronic device 1.

The number of wiring lines 38 may be determined depending on the number of contacts 35 included in the terminal component 30. Each of the wiring lines 38 is electrically connected to each contact 35. The wiring line 38 and the contact 35 electrically connected to each other may be integrally formed. A part of the wiring line 38 is mounted on the circuit board 16. The electrical signal transmitted from the external equipment to each contact 35 through the plug connector 2 is transmitted to the circuit board 16 via each wiring line 38. Further, the electrical signal transmitted from the circuit board 16 to each wiring line 38 is transmitted to the plug connector 2 via each contact 35.

The conductive member 40 illustrated in FIG. 5 may be made from metal or conductive materials except for metal. As illustrated in FIGS. 4 and 5, the conductive member 40 may include terminals 41A and 41B, a main body 42, arms 43A and 43B and conducting portions 44A and 44B. As illustrated in FIG. 4, the conductive member 40 includes two conducting portions 44A and 44B. However, the number of conducting portions included in the conductive member 40 is not limited to two, and it may be one or three or more.

Each of the terminals 41A and 41B illustrated in FIG. 5 is electrically connected to the ground of the electronic device 1. It is to be noted that a potential of any metal member may be used as the ground of the electronic device 1. For example, as the ground of the electronic device 1, a potential of a plate located on the Z-axis negative direction side of the receptacle connector 20 may be used. In this example, each of the terminals 41A and 41B may be electrically connected to the plate. In this case, the terminals 41A and 41B may be plate springs that can be elastically deformed in the Z-axis direction.

When each of the terminals 41A and 41B is electrically connected to the ground of the electronic device 1, the conductive member 40 can be connected to the ground of the electronic device 1. That is, the main body 42 and the conducting portions 44A and 44B included in the conductive member 40 can be connected to the ground of the electronic device 1.

As illustrated in FIG. 5, the main body 42 may cover the outside of the guide 22. When the main body 42 connected to the ground of the electronic device 1 covers the outside of the guide 22, the probability can be reduced that the electric noise from the plug connector 2 in the guide 22 will adversely affect the components in the electronic device 1. For example, when the first housing 14 illustrated in FIG. 3 serves as an antenna, the probability can be reduced that unnecessary resonance will be caused by the electric noise from the plug connector 2 in the guide 22. The unnecessary resonance is an unintended resonance generated in the operating frequency band of antenna.

The arm 43A illustrated in FIG. 5 extends from the main body 42 to the conducting portion 44A illustrated in FIG. 4. The arm 43B illustrated in FIG. 5 extends from the main body 42 to the conducting portion 44B illustrated in FIG. 4.

The conducting portion 44A may include an axis portion 45A, a contact portion 46A and a waterproof member 47A. The conducting portion 44B may include an axis portion 45B, a contact portion 46B and a waterproof member 47B.

The axis portion 45A may pass through the X-axis positive direction side of the second housing 15. In the same manner, the axis portion 45B may pass through the X-axis negative direction side of the second housing 15.

The contact portion 46A is exposed from the X-axis positive direction side of the guide 22. The contact portion 46A is electrically connected to a part of the X-axis positive direction side of the shell 2A illustrated in FIG. 1. In the same manner, the contact portion 46B is exposed from the X-axis negative direction side of the guide 22. The contact portion 46B is electrically connected to a part of the X-axis negative direction side of the shell 2A illustrated in FIG. 1. The contact portions 46A and 46B may be circular in shape as illustrated in FIG. 3.

As described above, the contact portion 46A of the conducting portion 44A and the contact portion 46B of the conducting portion 44B connected to the ground of the electronic device 1 are exposed to the inside of the guide 22, and can be electrically connected to the plug connector 2 illustrated in FIG. 1. When the contact portions 46A and 46B connected to the ground of the electronic device 1 are electrically connected to the plug connector 2, the probability can be reduced that the electric noise from the plug connector 2 will adversely affect the components in the electronic device 1. For example, when the first housing 14 illustrated in FIG. 3 serves as an antenna, as described above, the probability can be reduced that unnecessary resonance will be caused by the electric noise from the plug connector 2 in the guide 22. Therefore, according to this disclosure, an electronic device 1 provided with an improved receptacle connector 20 can be provided.

Here, in the USB Type C, among a plurality of contacts, a ground is assigned to each contact disposed on each of both ends. For example, with respect to a plurality of contacts 35 disposed along the X-axis as illustrated in FIG. 6, a ground is assigned to the contact 35 disposed at the end on the X-axis positive direction side and to the contact 35 disposed at the end on the X-axis negative direction side. In this embodiment, as described above, the contact portion 46A of the conducting portion 44A and the contact portion 46B of the conducting portion 44B are exposed from the portion of the X-axis positive direction side of the guide 22 and the portion of the X-axis negative direction side of the guide 22, respectively. When the contact portion 46A and the like are exposed from the portion and the like of the X-axis positive direction side of the guide 22, among a plurality of contacts 35, the contact 35 that may cause short circuit with contact portions 46A and 46B when dust is entered, for example, can be a contact to which a ground is assigned. With this configuration, in this embodiment, the safety of the electronic device 1 can be maintained.

It is to be noted that, when the receptacle connector 20 conforms to the Lightning® standard, according to the Lightning® standard, among a plurality of contacts, a ground is assigned to the contact disposed at one end. For example, with respect to a plurality of contacts disposed along the X-axis illustrated in FIG. 6, a ground is assigned to the contact disposed at the end on the X-axis negative direction side. In this case, the conductive member 40 may include only the conducting portion 44B of the two conducting portion 44A and 44B, the conducting portion 43B being exposed from the X-axis negative direction side of the guide 22. With this configuration, as described above, the safety of the electronic device 1 can be maintained. Further, when the receptacle connector 20 conforms to Mini-USB or Micro-USB, the conductive member 40 may also include only one conducting portion of the two conducting portions 44A and 44B.

The waterproof members 47A and 47B may each be an annular packing. The packing may be formed of elastic rubber material as with the above described waterproof member 37.

The waterproof member 47A seals at least a part between the axis portion 45A and the second housing 15. When the waterproof member 47A seals between the axis portion 45A and the second housing 15, the probability can be reduced that the water from the guide 22 will enter into the electronic device 1. The waterproof member 47B seals at least a part between the axis portion 45B and the second housing 15. When the waterproof member 47B seals between the axis portion 45B and the second housing, the probability can be reduced that the water from the guide 22 will enter into the electronic device 1.

As described above, the receptacle connector 20 according to this embodiment has the terminal component 30 configured to include the contact 35 opposed to the guide 22 and the guide 22 configured to guide the plug connector 2 inserted from the outside to the terminal component 30. In other words, the guide 22 and the terminal component 30 constitute the receptacle connector 20 having no metal shell. In this embodiment, since the receptacle connector 20 does not have a metal shell, the thickness of the electronic device 1 can be reduced.

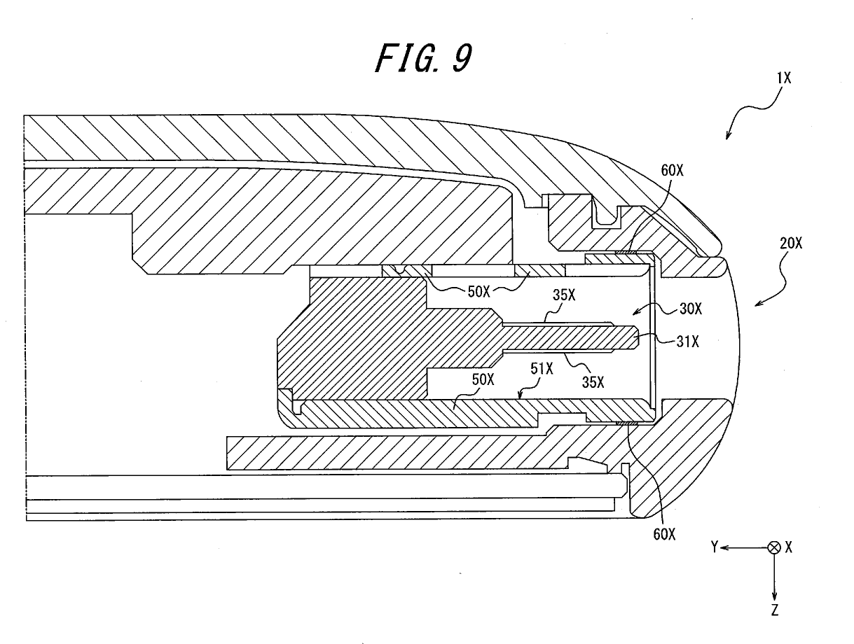

A receptacle connector having a metal shell will be explained below as a comparative example. FIG. 9 is a cross-sectional view of the electronic device 1X according to the comparative example.

The electronic device 1X comprises a receptacle connector 20X. The receptacle connector 20X has a terminal component 30X, a metal shell 50X and a waterproof member 60X. The terminal component 30X includes a base 31X and a plurality of contacts 35X.

The contacts 35X are opposed to the metal shell 50X. For example, the contacts 35X disposed on the face of the Z-axis negative direction side of the base 31X are opposed to the metal shell 50X located on the Z-axis negative direction side. For example, the contacts 35X disposed on the face of the Z-axis positive direction side of the base 31X are opposed to the metal shell 50X located on the Z-axis positive direction side.

The metal shell 50X is formed around the contacts 35. A part of a surface of the metal shell 50X serves as a guide 51X. The guide 51X guides the plug connector 2 from outside. The guide 51X can be a face approximately parallel to the XY plane such that it guides the plug connector 2 from outside.

The waterproof member 60X is an annular packing, for example. The waterproof member 60X is disposed on the outside of the metal shell 50X.

As described above, in the electronic device 1X according to the comparative example, the receptacle connector 20X has the metal shell 50X. In the electronic device 1X according to the comparative example, since the receptacle connector 20X has the metal shell 50X, the thickness of the electronic device 1X may increase. Furthermore, in the electronic device 1X according to the comparative example, the waterproof member 60X is disposed outside of the metal shell 50X. In the electronic device 1X according to the comparative example, since the waterproof member 60X is disposed outside of the metal shell 50X, the thickness of the electronic device 1X may further increase.

On the other hand, in the electronic device 1 according to this embodiment, the receptacle connector 20 does not have a metal shell. In the electronic device 1 according to this embodiment, since the receptacle connector 20 does not have a metal shell, a thickness of the electronic device 1 can be reduced. Moreover, in the electronic device 1 according to this embodiment, as illustrated in FIG. 3, the waterproof member 37 is located on the inside of the guide 22. With this configuration, in this embodiment, the thickness of the electronic device 1 can be further reduced. In addition, in the electronic device 1 according to this embodiment, the guide 22 can be formed at the housing 10. In other words, the receptacle connector 20 can be formed by utilizing the housing 10 of the electronic device 1. With this configuration, in this embodiment, the thickness of the electronic device 1 can be further reduced.

Further, in the electronic device 1X according to the comparative example, a part of the surface of the metal shell 50X serves as the guide 51X. Thus, in the electronic device 1X according to the comparative example, the probability increases that the shell 2A of the plug connector 2 will hit the metal guide 51A and be damaged.

On the other hand, in the electronic device 1 according to this embodiment, the guide 22 can have flexibility as described above. When the guide 22 has flexibility, even if the front end of the shell 2A hits the guide 22, the probability can be reduced that the front end of the shell 2A will be damaged.

Here, in the electronic device 1X according to the comparative example, as described above, the guide 51X can be a face approximately parallel to the XY plane. When the guide 51X is a face approximately parallel to the XY plane, the probability increases that, for example, the dust will enter between the guide 51X and the contact 35X and a short circuit will occur at either the guide 51X or a plurality of contacts 35X. That is, the probability increases that a short circuit will occur at, among a plurality of contacts 35X, a contact 35X to which an electrical signal is assigned and the guide 51X. When a short circuit occurs at the contact 35X to which an electrical signal is assigned and at the guide 51X, if the guide 51X is connected to the ground of the electronic device 1X, a short circuit may occur at the contact 35X and the ground of the electronic device 1.

In view of these elements, in the electronic device 1X according to the comparative example, it is assumed that the configuration in which the metal shell 50X is connected to the ground of the electronic device 1X is not adopted. In the electronic device 1 according to the comparative example, if the metal shell 50 is not connected to the ground of the electronic device 1X, the probability increases that unnecessary resonance will occur.

On the other hand, in the electronic device 1 according to this embodiment, as described above, the probability of occurrence of unnecessary resonance can be reduced by the conducting portions 44A and 44B. Furthermore, as described above, in the electronic device 1 according to this embodiment, even if the conducting portions 44A and 44B are connected to the ground of the electronic device 1, the safety of the electronic device 1 can be maintained.

FIG. 10 is a diagram of an example of a manufacturing process of the electronic device illustrated in FIG. 1. The process illustrated in FIG. 10 is a process of mounting the terminal component 30 and the like on a board. Hereinafter the process of mounting the terminal component 30 and the like on a board is referred to as a “mounting process.”

The board 16a includes a board for mounting 16b and a waste board 16c. The board for mounting 16b is a part of the board 16a. The waste board 16c is another part of the board 16a. In the Z-axis direction, the height of the board for mounting 16b is the same as that of the waste board 16c.

In the mounting process, a variety of components are mounted on the board for mounting 16b. For example, the fixed portions 34A and 34B illustrated in FIG. 6 are fixed to the board for mounting 16b to mount the terminal component 30 thereon. For example, the wiring line 38 of the terminal component 30 is mounted on the board for mounting 16b. The board for mounting 16b A on which a variety of components are mounted is the above described circuit board 16.

In the mounting process, among the portions included in the housing 32, portions on the side of the base 31 are disposed on the waste board 16c. The waste board 16c is detached from the board 16a after a variety of components are mounted on the board for mounting 16b. That is, the waste board 16c is detached from the housing 32 after a variety of components are mounted on the board for mounting 16b.

As described above, in the mounting process, among the portions included in the housing 32, the portions on the side of the base 31 are disposed on the waste board 16c. As described above, in the Z-axis direction, the height of the waste board 16c is the same as that of the board for mounting 16b, which can be the circuit board 16. Such process allows a part of the outer surface of the housing 32 to be located on the extension of the circuit board 16. Furthermore, the mounting process can be simplified by utilizing the waste board 16c instead of jigs and the like.

Although this disclosure has been described on the basis of drawings and embodiments, it is to be noted that a person skilled in the art can easily make a variety of modifications and changes on the basis of this disclosure. Therefore it is to be noted that these modifications and changes are included in the scope of this disclosure. For example, each component can be reordered in any logically consistent way, and components may be combined into one or divided.

1. An electronic device, comprising:
a terminal component configured to include a contact electrically connect to a plug connector; and
a guide configured to guide the plug connector inserted from outside to the terminal component, wherein
the guide and the terminal component constitute a receptacle connector having no metal shell.

2. An electronic device, comprising a receptacle connector having:
a terminal component configured to include a contact electrically connected to a plug connector; and
a guide configured to guide the plug connector inserted from outside to the terminal component, wherein
the contact is opposed to the guide.

3. The electronic device according to claim 2, wherein the contact is entirely opposed to the guide.

4. The electronic device according to claim 1, wherein
the electronic device further comprises a housing; and
the guide is formed at the housing of the electronic device.

5. The electronic device according to claim 1, wherein
the electronic device is plate-like shape; and
the guide is approximately parallel to the electronic device of a plate-like shape.

6. The electronic device according to claim 1, wherein the guide is non-conductive.

7. The electronic device according to claim 1, wherein
the receptacle connector further has a protrusion configured to protrude from the guide toward the terminal component; and
the protrusion comes into abutment with a front end of the plug connector.

8. The electronic device according to claim 1, wherein the terminal component further has a housing configured to hold the contact and a waterproof member configured to seal at least a part between the housing and the guide.

9. The electronic device according to claim 8, wherein
the receptacle connector further has a protrusion configured to protrude from the guide toward the terminal component; and
the waterproof member locates on the inner side of the electronic device than the protrusion.

10. The electronic device according to claim 1, wherein
the electronic device further has a circuit board on which the terminal component is fixed; and
the terminal component further includes a face in the vicinity of the contact, the face being located on an extension of the circuit board.

11. The electronic device according to claim 1, wherein the receptacle connector further has a conducting portion configured to be exposed from the guide and to be electrically connected to the plug connector.

12. The electronic device according to claim 1, wherein the receptacle connector conforms to Universal Serious Bus (USB) standard.

13. A receptacle connector, comprising:
a terminal component configured to include a contact electrically connected to a plug connector; and
a guide configured to guide the plug connector inserted from outside to the terminal component, wherein
the contact is opposed to the guide.
